(19) United States
(12) Patent Application Publication
(10) Pub. No.: US 2017/0094934 A1
(43) Pub. Date: Apr. 6, 2017

(54) MILKING DEVICE

(71) Applicant: LELY PATENT N.V., Maassluis (NL)

(72) Inventors: Paulus Jacobus Maria VAN ADRICHEM, Delfgauw (NL); Frank Gerard REGELINK, Delft (NL); Karel VAN DEN BERG, Bleskensgraaf (NL)

(73) Assignee: LELY PATENT N.V., Maassluis (NL)

(21) Appl. No.: 15/311,781

(22) PCT Filed: May 11, 2015
(86) PCT No.: PCT/NL2015/050327

§ 371 Date: Nov. 16, 2016

(30) Foreign Application Priority Data
May 28, 2014 (NL) 2012896

(51) Int. Cl. A01J 5/003; A01J 5/007; A01J 9/08; A01J 5/04; A01J 5/017

(52) U.S. Cl. CPC A01J 5/003; A01J 5/047; A01J 5/0175; A01J 9/08; A01J 5/007

(57) ABSTRACT

A milking device including a base frame, a functional frame coupled to the base frame and configured to move relative to the base frame with a teat detector and at least one milking cup holder with a milking cup to move relative to the milking cup holder. The functional frame can be filled relative to the base frame through an angle around at least one horizontal tilting axis transversely to a connection line between the teat detector and the milking cup holder. There may be two horizontal tilting axes, and consequently the functional frame can be subjected to a combination of a primary tilting movement and a secondary tilting movement. It is then possible to adjust an optimal level for the functional frame, and also an optimal mutual height relation of the teat detector and the milking cup in the milking cup holder.

The invention pertains in general to a milking device.

In particular, the invention pertains to a milking device comprising: a base frame; and a functional frame coupled to the base frame and moveable relative to the base frame, with teat detection means and at least one milking cup holder with a milking cup moveable relative to it.

Such a milking device is known, for example, from NL-1032433-C. The known milking device comprises a base frame in the form of a chassis having a horizontal part with wheels and a skid, as well as an upright part, and a functional frame in the form of a bottom part on which a housing is arranged. The milking device furthermore comprises a parallelogram construction, that is, an assembly of two parallel arms which join the functional frame to the base frame. The functional frame is adjustable in height by means of a piston and cylinder mechanism which is arranged between the base frame and one of the two arms. Four combinations of milking cup holders with milking cups able to move relative to it are connected to the functional frame. A teat detection camera is also mounted on the functional frame.

The milking cups are designed to be connected to the teats of the udder of a dairy animal such as a cow. By moving the piston of the piston and cylinder mechanism in and out, the arms of the parallelogram construction rotate, and the functional frame is adjusted in height. The height adjustment is desirable in order to place the milking cups at different (udder) heights. The functional frame can take up a lowermost position in which it is possible to milk dairy animals whose teats are only a few centimeters above the ground.

Although the known milking device works well in itself, there is a need to create an alternative milking device. In practice, it turns out that the teats of a dairy animal cannot always be properly seen by the teat detection camera. This holds in particular for low-hanging teats. There also appears to be a risk of the housing of the functional frame hitting the belly of a dairy animal whenever the functional frame is moved upward in order to connect the milking cups to the teats of the dairy animal. This is especially the case when the animal has a high udder and a portion of the animal's belly is situated at a lower level than the udder. Contact between the functional frame and the belly of a dairy animal can lead to stress in the animal and result in reactions of the animal such as kicking, and also instability of the milking device.

The invention proposes an alternative milking device not having the aforementioned drawbacks, or at least to a lesser degree. In particular, according to the invention, a milking device is created comprising: a base frame; a functional frame coupled to the base frame and moveable relative to the base frame, with teat detection means and at least one milking cup holder with a milking cup moveable relative to it; and tilting means for tilting of the functional frame relative to the base frame through an angle around at least one horizontal tilting axis transversely to a connection line between the teat detection means and the milking cup holder.

According to the invention, the milking device comprises tilting means for the tilting of the functional frame with respect to the base frame through an angle around at least one horizontal tilting axis transversely to a connection line between the teat detection means and the milking cup holder. For the sake of completeness it is noted that whenever this text speaks of a tilting through an angle, it is implicitly assumed that the angle is other than 0° , so that it can be an actual tilting. The above described problems connected with the prior art can apparently be solved by a design of the milking device in which the functional frame is tiltable in the indicated manner. Without the tilting, the view of the teats by the teat detection camera is hindered by the milking cups. Furthermore, without the tilting, there is a relatively large chance of stabbing the belly of a dairy animal with teat detection means extending above the milking cups, especially when the animal has a high udder and a portion of the animal's belly is at a lower level than the udder. Thanks to the present invention, one has the option of choosing to have the teat detection means sticking out less in the upward direction with respect to at least one milking cup holder with milking cup. For example, when it is especially important to perform an observation with the teat detection means, these means can be held at a higher level than the milking cups in the milking cup holder, thanks to a properly chosen level of the functional frame. In this case, the average viewing direction of the teat detection means will make a first angle with the horizontal. On the other hand, when it is primarily important to connect the milking cup to a teat of a dairy animal, the teat detection means can then be brought and held at a lower level with respect to the milking cups in the milking cup holder by tilting to a second angle for the average viewing direction, with more room for the belly of the dairy animal above the teat detection means as compared to situations with the milking device known from NL-1032433-C. The second angle here is preferably directed upward more than the first angle.

One favorable aspect of the invention is that the solution for the problems connected with the known milking device is not found in a changing of the configuration of the functional frame as such, so that the functional frame can be kept for the carrying of a number of components of the milking device which require a certain space after all. Instead, a solution has been found in the mentioned possibility of varying the angle of the functional frame relative to the base frame, especially a tiltable positioning of the functional frame in the milking device.

The at least one horizontal tilting axis according to the invention is situated transversely to a connection line between the teat detection means and the milking cup holder. “Transversely” here means both perpendicular to that connection line and essentially perpendicular, i.e., at an angle of at least 80° to that connection line. The connection line itself runs for example from a geometrical middle, center of gravity or longitudinal center line of the teat detection means to a geometrical middle or a point on a center line of the milking cup. If more milking cups are provided, then the connection line runs for example between said point of the teat detection means and the corresponding point of the group of milking cups. Note that the tilting of the milking cups themselves in nearly all cases will occur in a (vertical) plane parallel to the connection line. Furthermore, in most instances the functional frame with the one or more milking cups and the teat detection means will have a plane of (approximate) symmetry, and the tilting axis will be perpendicular to that plane.

It is advisable to make use in the invention of the possibility of height adjustment of the functional frame as is known from the prior art. This can be realized, for example, when the tilting means are designed to vary, by tilting of the functional frame relative to the base frame, the level of the functional frame as a whole with respect to the base frame. In particular, it may happen that the tilting axis traverses, that is, intersects the base frame, and is situated outside the functional frame. Every movement of the functional frame about the tilting axis then entails a changing of the angle of the functional frame with respect to the base frame, and furthermore a change in the (average) level of the functional frame due to the fact that the tilting axis is situated outside the functional frame.

Another option for the tilting axis is for it to traverse, that is, intersect the functional frame at a position between a section of the functional frame where the teat detection means are located and a section of the functional frame where the milking cup holder is located. In that case, a tilting of the functional frame about the tilting axis always entails a level change of the teat detection means and the milk cup holder in opposite directions. In other words, whenever the functional frame is tilted such that the teat detection means ascend, the milking cup holder will descend, and vice versa.

In one practical embodiment of the milking device according to the invention, use is made of both tilting axes as described above. In this case, the tilting means are thus oriented to tilt the functional frame with respect to the base frame through a first angle about a first tilting axis which traverses the base frame and is situated outside the functional frame, and through a second angle about a second tilting axis which traverses the functional frame at a position between a section of the functional frame in which the teat detection means are located and a section of the functional frame where the milking cup holder is located. As indicated, a tilting about the first tilting axis accomplishes not only a tilting of the functional frame but also a height adjustment of the functional frame, which is favorable to connecting the milking cup to a teat of a dairy animal, regardless of the height of the teat. Assuming that the teat detection means are closer to the first tilting axis than the milking cup holder, one can accomplish an upward movement in concert with a tilting of the functional frame, during which the teat detection means are lowered increasingly more as compared to the milking cup holder. Thus, there is also less risk of the teat detection means striking the belly of a dairy animal. With tilting movements about the second tilting axis, one can depart if desired from the relation existing between height adjustment and tilted level of the functional frame which exists for tilting movements about the first tilting axis. For example, if the milking cup in the milking cup holder blocks the view of the teat detection means when the functional frame after tilting about the first tilting axis has reached a certain level, the functional frame can then be tilted as it were back around the second tilting axis, until an acceptable mutual height relation is achieved for the teat detection means and the milking cups in the milking cup holder.

The tilting means can be arranged so that, upon a tilting of the functional frame through a first angle about the first tilting axis, a tilting of the functional frame through a second angle about the second tilting axis is automatically achieved. A changing of the level of the functional frame can then be related in a predetermined manner with a change in the tilted posture of the functional frame, that is, a change in the height relation of the teat detection means and the milking cup in the milking cup holder. Thus, for every possible level of the functional frame a practically favorable height relation of the teat detection means and the milking cup in the milking cup holder can be realized. It is not necessary to use complicated control means for this, since it is possible to realize mechanical couplings in the milking device, for example, by making use of arms which are coupled in various positions and in various manners to the base frame and the functional frame, as shall be further explained hereinafter. Note that as an alternative the tilting about the two tilting axes can advantageously occur independently of each other, at least such that the net orientation of the functional frame does not necessarily remain the same, or else the advantage of the invention cannot be obtained.

In one practical embodiment of the milking device according to the invention, the tilting means comprise a support arm for the interconnecting of the base frame and the functional frame, wherein the support arm is tiltable with respect to the base frame about the first tilting axis, and in particular wherein the functional frame is tiltable with respect to the support arm about the second tilting axis. Whenever such a support arm is rotated about the first tilting axis, the level at which the functional frame finds itself is changed, as is the angle of the functional frame with respect to the base frame. In the embodiment with the second tilting axis it is possible for this angle to be further adapted by tilting the functional frame relative to the support arm about the second tilting axis.

A rotation of the support arm about the first tilting axis can be achieved, for example, whenever the tilting means comprise a component with a variable length, one end of which is coupled to the base frame, and another end is coupled to the support arm, at a distance from the first tilting axis. The configuration of the base frame, the tilting arm, the functional frame and the component with the variable length can thus be such that whenever the length of the component increases, the functional frame is moved upward, and whenever the length of the component decreases, the functional frame is moved downward.

A tilting of the functional frame with respect to the support arm can likewise be accomplished by using a component with a variable length. It then involves a component whose one end is coupled to the support arm, and whose other end is coupled to the functional frame, at a distance from the second tilting axis.

As an alternative, the tilting means can comprise a flexible belt which can only be tensioned, being led along the support arm, and of which one end is coupled to the base frame, at a distance from the first tilting axis, and whose other end is coupled to the functional frame, at a distance from the second tilting axis. In this way, the tilting movement of the functional frame can be limited. If, starting from a relatively low initial position of the functional frame, by a rotation of the support arm about the first tilting axis the distance between the ends of the belt along the support arm becomes longer, the belt is tensioned and thereby produces a tilting of the functional frame with respect to the support arm in order to maintain the distance practically the same. Moreover, it may happen that if, at a given moment, the functional frame is tilted through a maximum angle, the distance between the ends of the belt along the support arm gets shorter upon a further rotation of the support arm about the first tilting axis, so that the belt becomes slack and no further movement of the functional frame can occur.

According to another alternative, which also provides for a limiting of the tilting movement of the functional frame, the tilting means comprise a control arm, one end of which is hinged to the base frame, at a distance from the first tilting axis, and whose other end is both hinged and able to slide in limited manner on the functional frame, at a distance from the second tilting axis. The control arm can be used in combination with the first mentioned support arm, but it is also possible to provide other means to accomplish in every instance a height adjustment of the functional frame as a whole. Because the control arm is both hinged and able to slide in limited manner on the functional frame, at a distance from the second tilting axis, the control arm can slide during an upward movement of the functional frame with respect to the functional frame and thereby pull it into a different tilted posture until no further sliding is possible. In one practical embodiment, the functional frame can be provided with a slotted hole, and the end of the support arm which is coupled to the functional frame can be provided with a pin or the like which is accommodated slickably in the slotted hole.

In yet other embodiments the tilting means comprise one or more motors having mutually rotatable parts, such as an electric motor, where the parts are coupled to the respective frames.

For practical use of the milking device according to the invention, it is favorable if the design of the tilting means is such that the functional frame can be moved between a starting position and a connecting position, wherein in the connecting position the functional frame as a whole is at a higher level than in the starting position, and where in the connecting position the functional frame is in a posture where the teat detection means are at a lower level in regard to the milking cup in the milking cup holder than in the starting position. It follows from the above that such a design of the tilting means can be accomplished in different ways.

When the functional frame is movable between the aforementioned starting position and connecting position, the functional frame in the starting position is at a relatively low level, so that the milking device can be easily moved underneath a dairy animal. Moreover, the tilted posture of the functional frame in the starting position is such that optimal use can be made of the teat detection means, wherein the milking cup is minimally present if at all in the visual field of the teat detection means. This improves the accuracy and/or speed of determining the position of a teat of the dairy animal. In the connecting position, the functional frame is at a higher level than in the starting position, and furthermore the functional frame has a different tilted posture. It is thus easily possible to connect the milking cup to the teat of the dairy animal, while the teat detection means are as much as possible out of the way, because the orientation of the functional frame is such that the teat detection means are at a relatively low level.

In addition, the milking device can be further provided with a height adjustment mechanism, designed to adjust the height of the functional frame with respect to the ground, as already described in NL-1032433-C.

Within the context of the invention, the milking device can be configured as a wheeled vehicle, especially an autonomous wheeled vehicle. For such vehicles it can be especially advantageous to make the least possible contact with a dairy animal, since that can result in undesirable instability. For example, in such an instance supplemental means will advantageously be provided for the milking, such as a pulsator and/or a milk storage container. Especially the milk storage container is then advantageously provided on the functional frame, so that this also tilts along if the functional frame is tilted when moving upward. It is also possible for the milking device to have a stationary section and a movable section, wherein the base frame, the functional frame and the tilting means are then part of the movable section, so that these components of the milking device can be positioned in a desired manner with respect to a dairy animal. In particular, one can conceive of a robot arm at a milking station such as a milking box or milking carousel.

The milking device can comprise a milking line connected to the milking cup and led across the functional frame. The milking device can also comprise means for generating a vacuum in the milking cup, which means are located on the functional frame. The milking line and the mentioned means require a certain amount of space. It is therefore not easy to adapt the design of the functional frame so that it does not touch the belly of a dairy animal when the functional frame is moving upward. It is a benefit of the invention that, with unchanged dimensions of the functional frame, the desired effect is still achieved of leaving more space before reaching the belly of a dairy animal.

It is favorable for the milking device to have a plurality of milking cup holders each with a milking cup which is movable relative to it, for example, four of them for cows and the like, or two for goats, so that it is possible with a single milking device to milk all the teats of a dairy animal at the same time.

The invention shall now be explained by means of the drawing, where individual nonlimiting example embodiments of a milking device with a base frame, a functional frame and a support arm for the interconnecting of the base frame and the functional frame are shown, the same reference numbers being used for identical or comparable parts, and wherein:

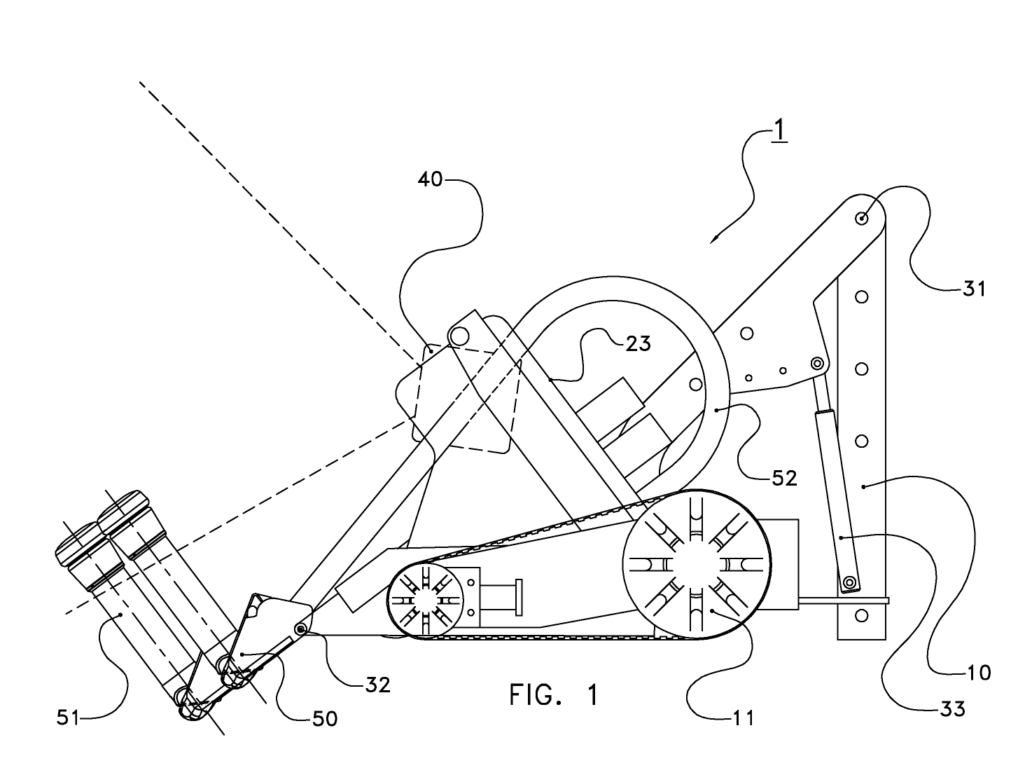

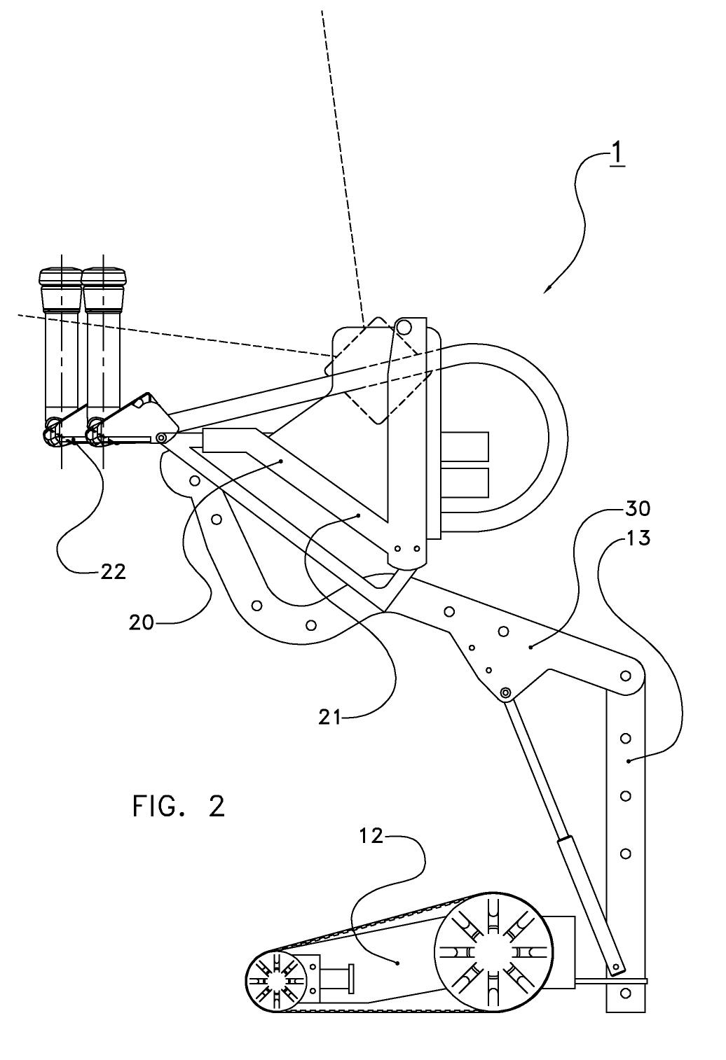

FIGS. 1 and 2 show schematically a side view of one embodiment of the milking device according to the invention in two different conditions, where FIG. 1 shows a condition of the milking device in which the functional frame is located in a starting position, and where FIG. 2 shows a condition of the milking device in which the functional frame is in a connecting position;

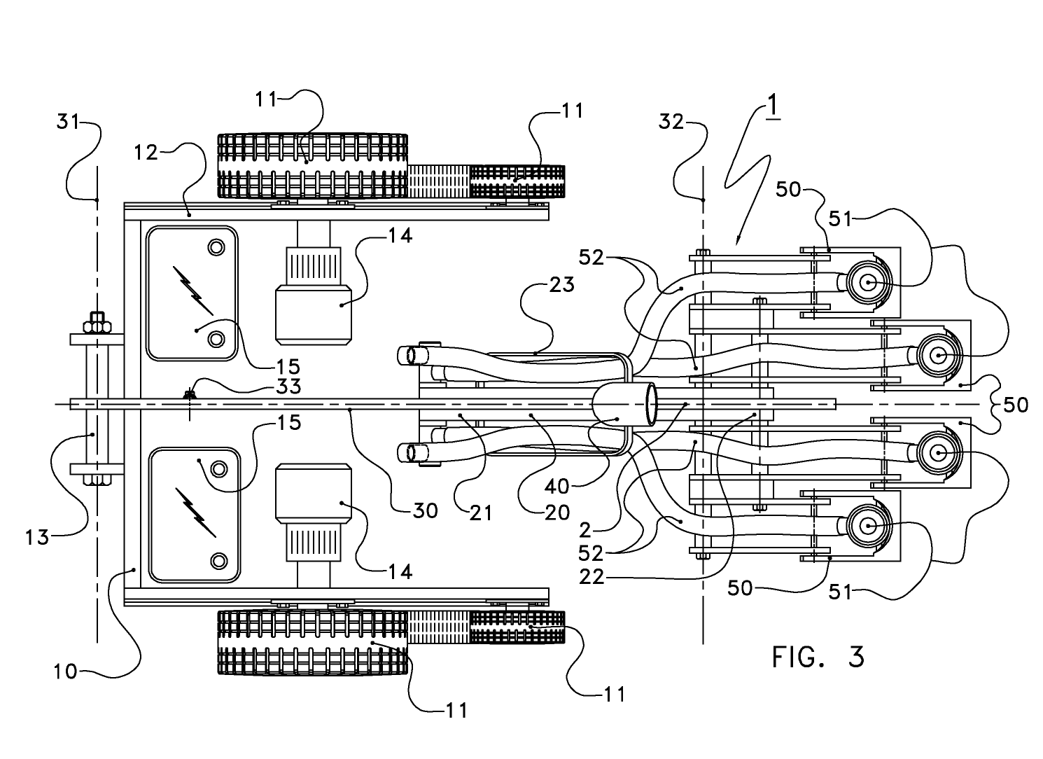

FIG. 3 shows schematically a top view of components of the embodiment shown in FIGS. 1 and 2 of the milking device according to the invention, in the mutual relationship which the components have in this embodiment, and

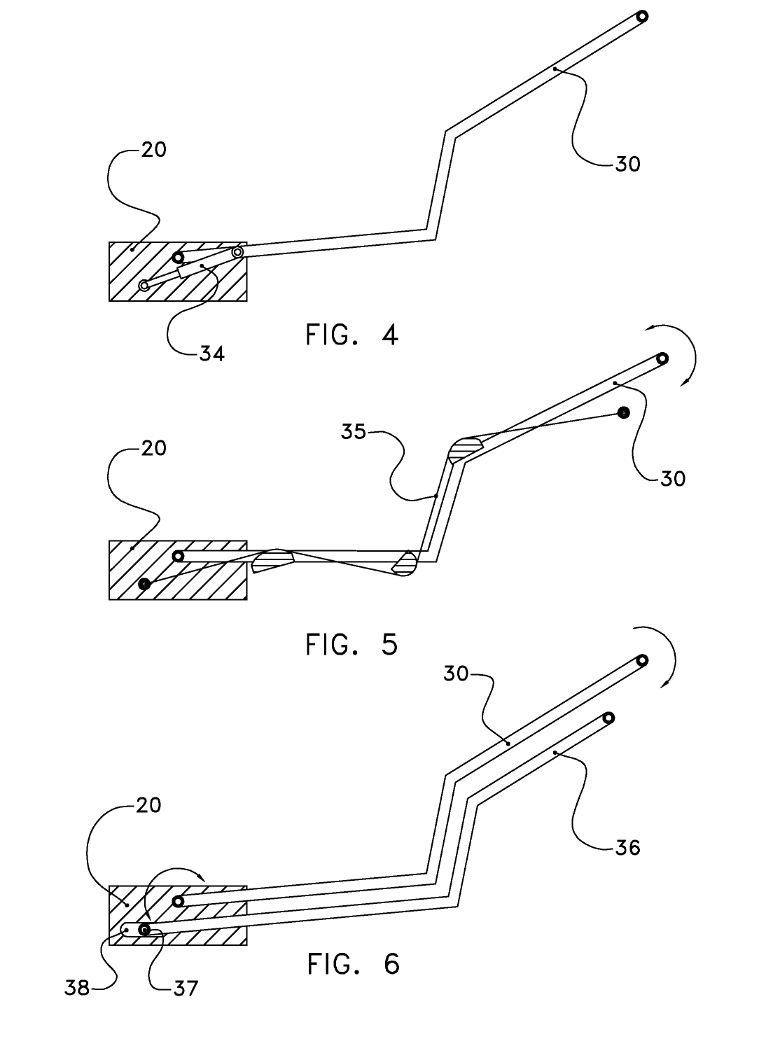

FIGS. 4, 5 and 6 illustrate three different options for a design with which it is possible to realize a tilting of the functional frame with respect to the support arm.

FIGS. 1 and 2 show schematically a side view of an embodiment of the milking device 1 according to the invention, in two different states, and FIG. 3 shows schematically a top view of components of said embodiment. The milking device 1 comprises a base frame 10, a functional frame 20 and a support arm 30 for the interconnecting of the base frame 10 and the functional frame 20. The functional frame 20 is movable with respect to the base frame 10, in a manner which will be explained below. On the functional frame 20 there are teat detection means 40 and a number of milking cup holders 50 each with a milking cup 51 able to move relative to the milking cup holder 50. The total of milking cup holders 50 and corresponding milking cups 51 is four, as shown in the top view of FIG. 3. The milking device 1 is designed to be adapted to the purpose of milking an animal (not shown), during which the milking cups 51 are connected to teats of the dairy animal.

In the example shown, the base frame 10 of the milking device 1 is provided with wheels 11, so that the milking device 1 is movable independently and therefore is able to drive underneath the teats of an animal being milked. The teat detection means 40 can comprise a camera and serve to ensure a correct course of the process in which the milking cups 51 are connected to the teats. For this, the teat detection means 40 are connected to a control means (not shown) of the milking device 1. To each of the milking cups 51 there is connected a milking line 52 to carry away the milk obtained during the milking from the milking cups 51 to a milk storage (not shown). The milk storage can comprise, for example, a separate milk tank with a permanent layout. Preferably, however, the milking device comprises a storage container, not shown here, which is provided on the independently movable vehicle. Specifically, the storage container is provided on the functional frame, so that the storage container can also be tilted upon upward movement of the functional frame.

It is practical for the milking device 1 to contain two motors 14 and batteries 15, as shown in FIG. 3. The batteries 15 serve to power the motors 14 and other components of the milking device 1, such as the teat detection means 40. The motors 14 serve to drive the wheels 11, preferably independently of each other, in order to ensure good maneuverability of the milking device 1.

The base frame 10 moreover comprises in the example shown a first support part 12 on which the wheels are located, and a second support part 13 which is an upright part as compared to the first support part 12. To the upper end of the second support part 13 is hinged a first end of the support arm 30. Therefore, a tilting axis can be designated for a tilting movement of the support arm 30 with respect to the base frame 10. In the case described below, this tilting axis shall be designated as the first tilting axis 31. For the sake of completeness, it is noted that terms such as “upper” and “lower” used in this text are deemed to refer to a normal orientation of the milking device 1 as shown in FIGS. 1 and 2, that is, an operational orientation in which the milking device 1 is suitable for being used for the milking of an animal

The functional frame 20 is hinged to a second end of the support arm 30. Therefore, a tilting axis can be designated for a tilting movement of the functional frame 20 with respect to the support arm 30. In what follows, this tilting axis shall be called the second tilting axis 32. In the example shown, the tilting axis 32 is located at a position on the functional frame 20 between a section 21 of the functional frame 20 where the teat detection means 40 are located and a section 22 of the functional frame 20 where the milking cup holders 50 and the milking cups 51 are located. The teat detection means 40 are arranged above a housing 23 which is situated on the functional frame 20, and which serves to accommodate components (not shown) of the milking device 1 such as means of generating a vacuum in the milking cups 51.

FIG. 1 shows the milking device 1 with the functional frame 20 in a starting position, while FIG. 2 shows the milking device 1 with the functional frame 20 in a connecting position. In the starting position, the functional frame 20 as a whole is situated at a lower level than in the connecting position. Moreover, the functional frame 20 in the starting position is as it were tilted forward as compared to an orientation which the functional frame 20 has in the connecting position, when the milking cups 51 in the milking cup holders 50 have a slanted orientation, and when the housing 23 with the teat detection means 40 has a higher position as compared to the milking cup holders 50 than in the connecting position. The functional frame 20 is moved from the starting position to the connecting position, and back again, by tilting movements of the support arm 30 about the first tilting axis 31 and tilting movements of the functional frame 20 about the second tilting axis 32, as shall be further explained below.

In general it should be noted in connection with the tilting axes 31, 32 that these have in normal use of the device a horizontal orientation and extend parallel to each other, parallel to the axles of the wheels 11, and therefore transverse to a travel direction of the milking device 1, as can be seen in the top view of FIG. 3. The tilting axes 31, 32 also extend transversely with respect to a connection line 2 between the teat detection means 40 and the milking cup holders 50. In the configuration of the milking device 1 as shown, said connection line 2 extends in the travel direction of the milking device 1, and the same holds for the support arm 30. In particular, said connection line 2 coincides here with a longitudinal center line of the support arm 30, a longitudinal center line of the teat detection means 40, and a longitudinal center line of the group milking cup holders 50. In the example shown, the functional frame 20 with the teat detection means 40 and the milking cup holders 50 each with a milking cup 51 is symmetrical in design, while a plane of symmetry extends in the vertical direction, transversely to the axles of the wheels 11. It can therefore also be said of the mentioned longitudinal center lines that these extend in the plane of symmetry of the functional frame 20, and of the tilting axes 31, 32 that these extend transversely to said plane of symmetry.

In one practical embodiment of the milking device 1, the milking cup holders 50 themselves are joined in tiltable fashion to the functional frame 20. In that case, each of the milking cup holders 50 is tiltable about a horizontal tilting axis which extends parallel to the first tilting axis 31 for the tilting of the support arm 30 with respect to the base frame 10 and the second tilting axis 32 for the tilting of the functional frame 20 with respect to the support arm 30. With a tiltable layout of the milking cup holders 50, there are further possibilities of varying the posture of the milking cups 51, especially an angle of the milking cups 51 with respect to the vertical, since they now no longer are directly related to a posture of the functional frame 20, but can be adjusted within a limited range independently of it.

For the purpose of the tilting of the support arm 30 relative to the base frame 10, the milking device 1 contains a piston and cylinder mechanism 33 which extends between a position on the base frame 10, especially a lower end of the second support part 13, and a position on the support arm 30, at a distance from the position where the support arm 30 is fastened to the base frame 10. In the event that the piston and cylinder mechanism 33 is extended outward, a tilting movement of the support arm 30 is realized, wherein the second end of the support arm 30 is placed at a higher level, and in the event that the piston and cylinder mechanism 33 is retracted inward, a tilting movement of the support arm 30 is realized wherein the second end of the support arm 30 is placed at a lower level. Consequently, upon extending of the piston and cylinder mechanism 33 the functional frame 20 as a whole is placed at a higher level, and upon a retracting of the piston and cylinder mechanism 33 the functional frame 20 as a whole is placed at a lower level.

The milking device 1 is designed to combine a tilting movement of the support arm 30 about the first tilting axis 31 with a tilting movement of the functional frame 20 about the second tilting axis 32. For the sake of clarity, the first mentioned tilting movement shall be designated hereafter the primary tilting movement and the last mentioned tilting movement shall be designated the secondary tilting movement. In general, the secondary tilting movement is meant to have the milking cups 51 in a functional state in the connecting position of the functional frame 20, that is, a state in which the milking cups 51 extend essentially in the vertical direction and are able to be connected onto the teats of a dairy animal. In the configuration shown for the functional frame 20 with the milking cup holders 50, the milking cups 51 and the housing 23 on it, with the detection means 40 thereupon, a functional state of the milking cups 51 goes hand in hand with an orientation of the functional frame 20 in which the teat detection means 40 extend upward less than the milking cups 51 in the starting position of the functional frame 20.

In the starting position of the functional frame 20 as shown in FIG. 1, the view of the teat detection means 40 is hampered as little as possible by the milking cups 51, so that the teats of a dairy animal can be easily observed. In the connecting position of the functional frame 20 as shown in FIG. 2, the viewing field of the teat detection means 40 is as it were tilted backward. To illustrate this fact, FIGS. 1 and 2 designate bottom surfaces and top surfaces of the viewing field with broken lines. The teat detection means 40 are also moved somewhat further backward, that is, more in the direction of a back line of the milking device 1 which coincides with a center line of the second support part 13, looking in the travel direction of the milking device 1. There is then a minimal risk of striking the belly of a dairy animal with the teat detection means 40 when connecting the milking cups 51 onto the teats of the dairy animal.

The secondary tilting movement can be coupled to the primary tilting movement, so that the primary tilting movement automatically entrains the secondary tilting movement. In what follows, we shall discuss three options by means of FIGS. 4, 5 and 6 for a design which makes it possible to realize the secondary tilting movement.

FIG. 4 illustrates a first option for realizing the secondary tilting movement. According to this option, a piston and cylinder mechanism 34 is used, which extends between a position on the support arm 30 and a position on the functional frame 20, at a distance from the position where the functional frame 20 is secured to the support arm 30. For the sake of clarity, hereinafter this piston and cylinder mechanism 34 shall be designated the secondary piston and cylinder mechanism 34, while the previously mentioned piston and cylinder mechanism 33 for the tilting of the support arm 30 relative to the base frame 10 shall be designated the primary piston and cylinder mechanism 33. The previously mentioned control means of the milking device 1 can be designed to control the posture of the secondary piston and cylinder mechanism 34 in dependence on the posture of the primary piston and cylinder mechanism 33. In the configuration shown, extending of the secondary piston and cylinder mechanism causes a tilting movement of the functional frame 20 in the one direction, in the representation of FIG. 4 a clockwise direction, and retraction of the secondary piston and cylinder mechanism causes a tilting movement of the functional frame 20 in the other direction, in the representation of FIG. 4 a counterclockwise direction. Whenever the functional frame 20 is moved from the starting position to the connecting position, the functional frame 20 on the basis of the primary tilting movement alone would be too far back, with a very low position of the teat detection means 40 as compared to the milking cups 51 in the milking cup holders 50, making practically impossible a functional adapting of the teat detection means 40 or at least greatly hampering it. With the secondary tilting movement the orientation of the functional frame 20 is as it were corrected, while the teat detection means 40 remain sufficiently low as compared to the milking cups 51 to minimize the risk of the teat detection means 40 striking the belly of the animal being milked. As shown for the milking device 1 in FIGS. 1 and 2, the primary tilting movement from the starting position to the connecting position is a clockwise movement, while the secondary tilting movement from the starting position to the connecting position is a counterclockwise movement.

FIG. 5 illustrates a second option for realizing the secondary tilting movement. According to this option, a flexible belt 35 is used, which is tensionable but not compressible, and which extends between a position on the base frame 10 and a position on the functional frame 20, at a distance from the position where the functional frame 20 is secured to the support arm 30. The flexible belt 35, for example, can be made of steel. In any case, the flexible belt 35 is laid along the support arm 30.

In the configuration shown, whenever the primary tilting movement is commenced to move the functional frame 20 from the starting position to the connecting position, the flexible belt 35 is tensioned and as a result the secondary tilting movement is initiated, whereupon the functional frame 20 is tilted clockwise. As the motion continues, at a given moment no more tensile force is exerted on the flexible belt 35, because the distance which is spanned by the flexible belt 35 along the support arm 30 no longer increases, and the flexible belt 35 becomes slack. The maximum secondary tilting movement is then attained.

FIG. 6 illustrates a third option for realizing the secondary tilting movement. According to this option, a control arm 36 is used, one end of which is hinged to the base frame 10, while another end is hinged and able to slide in limited manner with the functional frame 20, at a distance from the position where the functional frame 20 is secured to the support arm 30. In the example shown, the latter mentioned end of the control arm 36 is provided with a pin 37, and the functional frame 20 is provided with a slotted hole 38 in which the pin 37 is accommodated.

In the configuration shown, whenever the primary tilting movement is initiated to move the functional frame 20 from the starting position to the connecting position, the pin 37 secured to the control arm 36 slides in the slotted hole 38 and as a result the secondary tilting movement is initiated, whereupon the functional frame 20 is tilted clockwise. As the movement continues, the pin 37 at a given moment reaches the end of the slotted hole 38, and the control arm 36 forms with the support arm 30 a parallelogram construction. The maximum secondary tilting movement is then reached.

It will be clear to the skilled person that the scope of the invention is not limited to the examples discussed above, but rather different variations and modifications thereof are possible without departing from the scope of the invention as defined in the appended claims.

Even though in each of the examples discussed above a support arm 30 is used to connect the functional frame 20 to the base frame 10, the support arm 30 is no essential part of the milking device 1 according to the invention. What is important is that the functional frame 20 is coupled to the base frame 10 and is movable relative to the base frame 10. This can be realized in different ways, including ways which do not entail the use of any support arm 30. Moreover, it is noted that the number of combinations of milking cup holder 50 and corresponding milking cup 51 can be chosen freely within the context of the invention.

According to the invention, means are used to make possible the tilting of the functional frame 20 with respect to the base frame 10 through an angle about at least one horizontal tilting axis 31, 32 transversely to a connection line between the teat detection means 40 and the milking cup holder 50. These means can comprise the primary piston and cylinder mechanism 33 as shown, and in addition one of the secondary piston and cylinder mechanism 34, the flexible belt 35 and the control arm 36 as shown, but this does not mean that there are no alternatives within the context of the invention.

The invention can be summarized as follows. A milking device 1 comprises a base frame 10, a functional frame 20 coupled to the base frame 10 and able to move relative to the base frame 10 with teat detection means 40 and at least one milking cup holder 50 with a milking cup 51 able to move relative to it. The milking device 1 is designed so that it is possible to tilt the functional frame 20 relative to the base frame 10 through an angle around at least one horizontal tilting axis 31, 32 transversely to a connection line between the teat detection means 40 and the milking cup holder 50. Preferably there are two horizontal tilting axes 31, 32, and consequently the functional frame 20 can be subjected to a combination of a primary tilting movement and a secondary tilting movement. It is then possible to adjust an optimal level for the functional frame 20, and also an optimal mutual height relation of the teat detection means 40 and the milking cup 51 in the milking cup holder 50. In this way, the functional frame 20 with the components thereupon can be placed in a starting position unhindered beneath the belly of an animal being milked and then moved into a connecting position, with the least possible hindrance of the teat-detecting function of the detection means 40 and with the least possible risk of the teat detection means 40 striking the belly of the dairy animal.

1-15. (canceled)

16. A milking device comprising:
a base frame;
a functional frame coupled to the base frame and moveable relative to the base frame, including teat detection means and at least one milking cup holder with a milking cup moveable relative to the milking cup holder; and
tilting means for tilting of the functional frame relative to the base frame through an angle around at least one horizontal tilting axis transversely to a connection line between the teat detection means and the milking cup holder.

17. The milking device as claimed in claim 16, wherein the tilting means is configured to vary, by the tilting of the functional frame relative to the base frame, a level of the functional frame as a whole with respect to the base frame, and wherein the tilting axis traverses the base frame and is situated outside the functional frame.

18. The milking device as claimed in claim 16, wherein the tilting axis traverses the functional frame at a position between a section of the functional frame where the teat detection means is located and a section of the functional frame where the milking cup holder is located.

19. The milking device as claimed in claim 16, wherein the tilting means is oriented to tilt the functional frame with respect to the base frame through a first angle about a first tilting axis which traverses the base frame and is situated outside the functional frame, and through a second angle about a second tilting axis which traverses the functional frame at a position between a section of the functional frame in which the teat detection means is located and a section of the functional frame where the milking cup holder is located.

20. The milking device as claimed in claim 19, wherein the tilting means is configured so that, upon a tilting of the functional frame through a first angle about the first tilting axis, a tilting of the functional frame through a second angle about the second tilting axis is automatically achieved.

21. The milking device as claimed in claim 19, wherein the tilting means comprises a support arm for interconnecting of the base frame and the functional frame, wherein the support arm is tiltable with respect to the base frame about the first tilting axis, and wherein the functional frame is tiltable with respect to the support arm about the second tilting axis.

22. The milking device as claimed in claim 21, wherein the tilting means comprises a component with a variable length, one end of which is coupled to the base frame, and another end is coupled to the support arm, at a distance from the first tilting axis.

23. The milking device as claimed in claim 21, wherein the tilting means comprises a component with a variable length, whose one end is coupled to the support arm, and whose other end is coupled to the functional frame, at a distance from the second tilting axis.

24. The milking device as claimed in claim 21, wherein the tilting means comprises a flexible belt which is only tensionable, being led along the support arm, and of which one end is coupled to the base frame, at a distance from the first tilting axis, and whose other end is coupled to the functional frame, at a distance from the second tilting axis.

25. The milking device as claimed in claim 19, wherein the tilting means comprises a control arm, one end of which is hinged to the base frame, at a distance from the first tilting axis, and whose other end is both hinged and configured to slide in a limited manner on the functional frame, at a distance from the second tilting axis.

26. The milking device as claimed in claim 16, wherein the tilting means is configured to move the functional frame between a starting position and a connecting position, wherein in the starting position the functional frame as a whole is at a higher level than in the starting position, and wherein in the connecting position the functional frame is in a posture where the teat detection means is at a lower level in regard to the milking cup in the milking cup holder than in the starting position.

27. The milking device as claimed in claim 16, configured as a wheeled vehicle, or an autonomous wheeled vehicle, and further comprising milking means or a pulsator and/or a milk storage container provided on the functional frame.

28. The milking device as claimed in claim 16, further comprising a stationary section and a movable section, wherein the base frame, the functional frame, and the tilting means are part of the movable section.

29. The milking device as claimed in claim 16, further comprising at least one milking line connected to the milking cup and led across the functional frame, and means for generating a vacuum in the milking cup, which means is located on the functional frame.

30. The milking device as claimed in claim 16, comprising a plurality of milking cup holders with a milking cup moveable relative to the milking cup holders.
